(19) United States
(12) Patent Application Publication
(10) Pub. No.: US 2003/0176617 A1
(43) Pub. Date: Sep. 18, 2003

(54) High performance sealant formulations based on MDI prepolymers

(76) Inventor: Chin-Chang Shen, Rochester, MI (US)

Correspondence Address: Patent Counsel, Huntsman Polyurethanes, 286 Mantua Grove Road, West Deptford, NJ, 08066-1732, US

(21) Appl. No.: 10/414,803

(22) Filed: Apr. 16, 2003

Related U.S. Application Data
(63) Continuation of application No. PCT/US01/43045, filed on Oct. 22, 2001.
(60) Provisional application No. 60/242,558, filed on Oct. 23, 2000.

(51) Int. Cl. C08G 18/00

(52) U.S. Cl. 528/44

(57) ABSTRACT

Disclosed are certain moisture curable prepolymers formed by the reaction of diphenylmethane diisocyanate (MDI) with conventional polyether polyols to produce sealants and coatings exhibiting excellent combinations of physical properties, most notably, high tensile strength, high tear resistance, and high elongation. These combinations of physical properties in the moisture-cured polymer are superior to those obtained from prepolymers of the so-called “low unsaturation” polyether polyols. The moisture curable prepolymers offer improved polymer properties, reduced viscosity, and lower raw materials cost in relation to the prior art prepolymers based on low unsaturation polyether polyols.

### CROSS-REFERENCE TO RELATED APPLICATIONS

This application claims the benefit of U.S. Provisional Application No. 60/242,558, filed on Oct. 23, 2000, the subject matter of which is herein incorporated by reference. This application is also a continuation of international application PCT/US01/43045, filed Oct. 22, 2001.

### TECHNICAL FIELD

The invention is directed to isocyanate terminated urethane prepolymers suitable for use as moisture curable one component sealants. The prepolymers of the invention may also be used to prepare coatings and adhesives by the moisture cure method.

### BACKGROUND ART

Polyurethane thermoset elastomeric sealants are one of the fastest growing sectors of the sealant industry. Major application areas for sealants of this type are found in construction and in the automotive industry. Elastomeric sealants are particularly useful in construction, for sealing movable joints in structures. Sealants of this type may optionally be foamed during the curing process. These are referred to as air infiltration sealing foams. Important automotive uses include windshield sealants. In the construction industry, polyurethane elastomers are classified along with silicones and polysulfides as high performance sealants, due to their high elasticity. This elasticity is particularly important in sealing movable joints between building panels. The elastomer must withstand both compression (when building panels expand during summer) and tension (when building panels contract during winter). Mechanical strength, resistance to tearing, and high elongation are therefore very important in these kinds of sealant applications.

Liquid one component sealant precursors that cure rapidly when exposed to atmospheric moisture under ambient conditions are known in the art. The use of isocyanate terminated prepolymers and pseudo prepolymers as moisture curing sealants is also well known. Sealant precursors of this type are easy to use. They may optionally be foamed during the moisture curing process, depending on the conditions of sealant precursor (prepolymer) application and cure. Prepolymers with low free isocyanate (—NCO) content tend to moisture cure more rapidly and to provide greater ease of control with regard to the degree of foaming. Prepolymers with lower free —NCO levels also yield polymers with greater elasticity upon curing. This is a major advantage. Unfortunately, there is a trade off between the free —NCO content of the prepolymer and its viscosity. The lower the free —NCO content, the higher the viscosity of the prepolymer. Processing becomes very difficult if the viscosity of the prepolymer (at 25° C.) is significantly greater than about 30,000 cps. An object of this invention is to provide moisture curable isocyanate terminated urethane prepolymers, suitable for use as one-component sealant precursors, which have viscosities below 30,000 cps at 25° C.

In order to achieve elasticity in the cured sealant, the prepolymer must contain the reaction product of a flexible polyol. The flexible polyol provides a soft segment in the cured sealant, the soft segment being characterized by having a glass transition temperature below ambient temperature. Preferably, the glass transition temperature of the soft segment phase in the elastomer is about −20° C. or lower, so that the cured sealant retains its elastic properties even at the lowest temperatures it is likely to encounter during normal use. The preferred flexible polyols for use in preparing moisture curing sealant prepolymers are polyether type polyols. Polyether polyols are relatively inexpensive, and are very resistant to hydrolysis. Polyether polyols of relatively high equivalent weight, typically greater than about 500, are required in order to produce soft segments with sufficiently low glass transition temperatures in the cured sealant. Generally, the higher the equivalent weight of a polyether polyol, the lower glass transition temperature of the soft segment in the cured sealant elastomer. Polyether polyols suitable for use as the flexible soft segments in the elastomer typically have from about 2 to about 5 terminal hydroxyl groups per molecule. This is the nominal functionality of the polyol. Trifunctional flexible polyether polyols (triols) having number averaged molecular weights of from about 2000 to about 6000 are the currently predominant polyols used in the production of one component moisture curable prepolymers for sealant applications.

The high molecular weight flexible polyols, typically used in making moisture curable isocyanate terminated prepolymers as sealant precursors, are almost invariably polymers of propylene oxide. Propylene oxide is the preferred monomer used for preparing such polyols, due to its low cost and wide availability. Polymers of propylene oxide typically have very low glass transition temperatures. The propylene oxide is sometimes copolymerized with relatively minor amounts of ethylene oxide, usually as a “cap” at the hydroxyl termini of the polyol. The manufacture of polyether polyols from propylene oxide is amply described in the prior art. Most conventionally, these polyols are made by the based catalyzed polyaddition of propylene oxide (and optionally ethylene oxide) onto a polyfunctional initiator, such as glycerol or trimethylol propane, in the presence of a base catalyst such as KOH. The nominal functionality of the polyol is the functionality of the initiator. Thus the propoxylation of glycerol gives a nominal triol. A well-known problem with the conventional synthesis of high molecular weight polyols based on propylene oxide is the co-production of minor amounts of terminally unsaturated mono-ols. In the conventional manufacturing process the relative concentration of these unsaturated mono-ol impurities in the final polyether polyol increases with the degree of propoxylation or, in other words, with the hydroxyl equivalent weight of the polyol. As a consequence of the mono-ol impurities in conventional polyether polyols the real functionality (number averaged) of these polyols is much lower than the nominal functionality. For example, a nominal triol with a hydroxyl equivalent weight of about 2000 will have a number averaged functionality of 1.5 or less. At higher equivalent weights the real functionality drops off significantly further. The final polyol is, of course, a mixture of the expected polyether triol and significant monol amounts of polyether mono-ols with allylic terminal unsaturation. Polyether polyols are typically characterized as to their degree of terminal unsaturation, due to these monofunctional species. The unsaturation in polyether polyols is usually expressed as meq/g of terminal unsaturation, due to these mono-ol by products of manufacture. For a 2000 equivalent weight nominal triol, made by the conventional KOH catalyzed process, the unsaturation would typically be about 0.07 to 0.08 meq/g.

One would generally expect the presence of mono-ols in a polyurethane elastomer formulation to result in a polymer with less than optimal physical properties, due to the many imperfections in the elastomeric network caused by the chain stopping effect of the mono-ols. Indeed, one would expect that the properties of the elastomer that would suffer most would be tensile strength, tear resistance, and ultimate elongation. In part as a result of these intuitive expectations, the industry has recently seen the commercialization of a number of specialized flexible (high equivalent weight) polyether polyols that have greatly reduced unsaturation levels. Levels of unsaturation below 0.01 meq/g are now routinely achieved. These low unsaturation polyether polyols are made with unconventional catalysts. The catalysts and the manufacturing processes are generally more complex than for conventional polyether polyols. As a result, the low unsaturation flexible polyether polyol products tend to be more expensive, and more limited in availability, than the conventional flexible polyether polyols (as made, for example, by KOH catalysis). As a result of their relatively high cost, these specialized low unsaturation polyols have been targeted for use in niche applications. High performance polyurethane sealants is one of these target applications. The following U.S. Patents mention one component moisture curing sealant formulations based on specialized low unsaturation polyether polyols: U.S. Pat. Nos. 5,696,221; 5,695,778; 5,849,944; 5,728,745; 5,670,601; 5,677,413; 5,792,829; and 5,563,221.

An object of the invention is the development of moisture curing sealant prepolymer formulations based on conventional flexible polyether polyols, which formulations offer sealant properties superior to those obtained in the prior art using the specialized low unsaturation polyether polyols.

### DISCLOSURE OF INVENTION

The invention relates to a urethane prepolymer composition suitable for use as a moisture curable one component sealant precursor, the prepolymer comprising the reaction product of:

A) a base isocyanate composition including;

i) about 40-100% by weight of 4,4′-diphenylmethane diisocyanate,

ii) optionally up to about 55% by weight of 2,4′-diphenylmethane diisocyanate,

iii) optionally up to about 2% by weight of 2,2′-diphenylmethane diisocyanate, and

iv) a total of 0 to about 5% by weight, preferably from 0.1 to 5% by weight, of one or more members selected from the group consisting of uretonimine or uretonimine-carbodiimide modified diphenylmethane diisocyanate species of functionality greater than 2.0, and tri- or higher functionality oligomers of the polymethylene polyphenyl polyisocyanate series;

wherein the combined weights of i-iv add up to 100%, and the number averaged isocyanate group functionality of the base isocyanate composition is from about 2.00 to about 2.03;

B) a combination of polyether polyols including;

i) from about 60 to about 90% by weight of a polyoxyethylene terminated polyoxypropylene nominal diol having a number averaged hydroxyl equivalent weight of from about 1200 to about 2500, a concentration of terminally unsaturated species of not less than 0.03 meq/g, and a terminal oxyethylene content of from 22 to about 40% by weight,

ii) from about 10 to about 25% by weight of a polyoxyethylene terminated polyoxypropylene nominal triol or tetrol having a number averaged hydroxyl equivalent weight of from about 1200 to about 2500, a concentration of terminally unsaturated species of not less than 0.04 meq/g, and a terminal oxyethylene content of from about 5 to about 25% by weight, and

iii) from about 5 to about 15% by weight of a polyoxypropylene or a polyoxyethylene terminated polyoxypropylene nominal diol having a number averaged hydroxyl equivalent weight from about 500 to less than about 1200, a concentration of terminally unsaturated species of not less than 0.015 meq/g, and a terminal oxyethylene content of from 0 to about 10%,

wherein the total weights of the polyether polyol components i-iii add up to 100%; and

C) optionally an inert and substantially non-volatile diluent, in an amount less than 15% by weight of the total urethane prepolymer composition [A+B+C];

wherein said urethane prepolymer composition is further characterized by being liquid at 25° C., having a final concentration of free isocyanate (—NCO) groups of from about 5 to about 12%, and a viscosity at 25° C. of less than 15,000 cps.

The prepolymers of the invention are storage stable liquids at ambient temperature and may be used directly as one-component systems which can be cured in the presence of atmospheric moisture at ambient temperatures to form essentially bubble free sealant elastomers, coatings, and adhesives. Optionally, the prepolymers of the invention may be further reacted with polyols in order to reduce their free —NCO content further at the point of use. The prepolymers of the invention or their derivatives of reduced free —NCO content may optionally be capped, fully or partially, with moisture crosslinkable isocyanate-reactive silanes such as amino or hydroxy functional trialkoxysilanes. The prepolymers of the invention offer improved processing due to their relatively low viscosities, and improved combinations of mechanical properties in the derived moisture cured polymers. The prepolymers of the invention are prepared from conventional polyether polyols, and do not require the use of specialized polyether polyols with unusually low level of terminal unsaturation (mono-ol content).

### BEST MODES FOR CARRYING OUT THE INVENTION

There is now provided a general formulation for MDI-based isocyanate terminated one-component moisture curing prepolymers. The precursors are urethane prepolymers derived from conventional polyoxypropylene based flexible polyether polyols. The polyether polyols are the source of the soft segments in the derived elastomers. The cured elastomers made from the prepolymers of the invention generally exhibit tensile, tear, and elongation properties superior to those obtained from specialized low unsaturation polyoxypropylene based polyether polyols. The prepolymers according to the invention have viscosities that are low enough for effective processing in existing thermoset sealant applications.

The prepolymers of the invention are prepared by reacting a certain base MDI formulation with a specified combination of flexible polyether polyols. The prepolymers may also contain a minor amount of an inert and essentially non-volatile diluent. The polyether polyols are each based predominantly on propylene oxide and are prepared by conventional processes involving the polymerization of propylene oxide, and ethylene oxide, onto low molecular weight initiators in the presence of a base catalyst. Potassium hydroxide (KOH) is the preferred base catalyst for the formation of these conventional polyether polyols. Specialized low unsaturation polyether polyols are not used. The flexible polyether polyols used in making the prepolymers of the invention are predominantly nominal diols. The flexible polyether polyols are characterized by having their minimum hydroxyl equivalent weights of 500 or greater, preferably at least 1000. These polyols contribute flexibility (elasticity) to the cured elastomers.

The MDI based prepolymers of the invention are characterized by having final free isocyanate (—NCO) concentrations in the range of from about 5 to about 12% by weight, preferably from about 7 to about 11%, and most preferably from about 8 to about 10%. The ideal value is 8%. These prepolymers are in fact pseudo-prepolymers, in that they contain some residual monomeric MDI species. The prepolymers are further characterized by having a viscosity at 25° C. of less than about 30,000 cps, preferably less than about 10,000 cps, more preferably less than about 5000 cps, still more preferably less than about 4000 cps, most preferably less than about 3000 cps, and ideally less than about 2500 cps. The prepolymers are liquids at ambient temperatures (25° C.) and may be stored without forming solids. The prepolymers are preferably storage stable for at least one month at 25° C., preferably for at least 3 months, and most preferably for at least 6 months at 25° C. without discoloration or cloudiness.

The base MDI composition is a low functionality blend of diphenylmethane diisocyanate isomers, derivatives, and optionally small amounts of higher oligomers of the polymethylene polyphenyl polyisocyanate series. The ratio of the diphenylmethane diisocyanate isomers in the base MDI composition may be varied over a wide range. This is important, in as much as the relative proportions of 4,4′-MDI and 2,4′-MDI have a significant influence on the flexural modulus (and hardness) of the elastomers ultimately derived from the prepolymers. The flexural modulus (hardness) must be adjusted to match the end use application. Higher levels of 4,4′-MDI result in higher modulus (hardness) whereas higher 2,4′-MDI levels produce softer (lower modulus) elastomers. The base MDI composition is characterized by having a number averaged isocyanate (—NCO) group functionality in the range of 2.00 to about 2.03, preferably 2.00 to 2.02, and more preferably greater than 2.00 to less than 2.01. Higher functionality in the base MDI composition results in higher viscosity in the derived prepolymers. The base MDI preferably includes the following ingredients in the relative amounts indicated:

i) about 40-100% by weight of 4,4′-diphenylmethane diisocyanate, preferably 50 to 99% by weight,

ii) optionally up to about 55% by weight of 2,4′-diphenylmethane diisocyanate, preferably 50 to 0.01% by weight,

iii) optionally up to about 2% by weight of 2,2′-diphenylmethane diisocyanate, preferably less than 0.5% by weight, and

iv) a total of 0 to 5%, preferably 0.1 to 5%, more preferably 1 to 3%, by weight of one or more members selected from the group consisting of uretonimine or uretonimine-carbodiimide modified diphenylmethane diisocyanate species of functionality greater than 2.0, and tri- or higher functionality oligomers of the polymethylene polyphenyl polyisocyanate series;

wherein the total weights of i-iv add up to 100% by weight.

The preferred species for optional ingredient iv of the base MDI composition are uretonimine-carbodiimide modified diphenylmethane diisocyanate species. An example of a particularly preferred uretonimine-carbodiimide modified diphenylmethane diisocyanate species suitable for use as ingredient iv in the base MDI composition is RUBINATE® 1680 isocyanate, which is commercially available from Huntsman Polyurethanes. RUBINATE® 1680 is a partially uretonimine-carbodiimide modified variant based on 4,4′-MDI. This variant is liquid at 25° C., has a number averaged isocyanate functionality under 2.1, and has a free —NCO content of about 29.3% by weight.

Although less preferred, it is within the scope of the invention to incorporate minor amounts of isocyanate species other than MDI isocyanates into the prepolymers of the invention. When present at all, these non-MDI isocyanates should comprise less than 10% by weight of the base isocyanate composition, preferably less than 5%, more preferably less than 2%, and most preferably less than 1% by weight of the base isocyanate composition. As non-limiting examples of non-MDI isocyanates which might be included in the prepolymer composition at minor levels would be one or more members of the toluene diisocyanate isomers, or one or more aliphatic di and/or tri isocyanate species.

The base MDI composition is reacted with a specific combination of flexible polyether polyols. The flexible polyether polyol combination includes:

i) from about 60 to about 90%, preferably about 70 to about 85%, by weight of a polyoxyethylene terminated polyoxypropylene nominal diol having a number averaged hydroxyl equivalent weight of from about 1200 to about 2500, a concentration of terminally unsaturated species of not less than 0.03 meq/g, and a terminal oxyethylene content of from about 22 to about 40% by weight,

ii) from about 10 to about 25%, preferably about 15 to about 20%, by weight of a polyoxyethylene terminated polyoxypropylene nominal triol or tetrol having a number averaged hydroxyl equivalent weight of from 1200 to about 2500, a concentration of terminally unsaturated species of not less than 0.035 meq/g, and a terminal oxyethylene content of from about 5 to about 25% by weight,

iii) from about 5 to about 15%, preferably about 8 to about 12%, by weight of a polyoxypropylene or a polyoxyethylene terminated polyoxypropylene nominal diol having a number averaged hydroxyl equivalent weight from 500 to less than 1200, a concentration of terminally unsaturated species of not less than 0.015 meq/g, and a terminal oxyethylene content of from 0 to about 10%,

wherein the total weights of i-iii add up to 100% by weight.

Preferably, the minimum number averaged hydroxyl equivalent weight of polyol ingredient i is greater than 1500. The preferred minimum oxyethylene content of polyol i is in the range of greater than 25% to less than 35%, more preferably 26% to 30%.

Preferably, the minimum number averaged hydroxyl equivalent weight of polyol iii is greater than 800, more preferably about 1000. The maximum number averaged hydroxyl equivalent weight of polyol iii is less than 1100.

Polyol ii is preferably a nominal triol, rather than a nominal tetrol.

The flexible polyether polyols used to prepare the prepolymers of the invention are each individually prepared by the base catalyzed reaction of propylene oxide and, if appropriate, ethylene oxide, onto a suitable initiator species. The preferred initiators are low molecular weight diols, for polyols i and iii; and low molecular weight triols for polyol ii. Other types of active hydrogen containing initiator species, such as amines or thiols, may be used provided they result in the indicated nominal functionality for the respective polyol. Examples of suitable difunctional initiators include ethylene glycol, propylene glycol, diethylene glycol, triethylene glycol, dipropylene glycol, tripropylene glycol, water, 1,4-butanediol, 1,3-butanediol, 1,4-butenediols, 1,4-butyndiol, Bisphenol-A, hexanediols, 1,3-propanediol, pentanediols, mixtures of these, and the like. The preferred diol initiators are aliphatic diols having 2 to 10 carbon atoms. Examples of suitable triol initiators include glycerol, trimethylol propane, trimethylol ethane, 1,3,6-hexanetriol, 1,3,5-trihydroxybenzene, mixtures of these, and the like. The preferred triol initiators are aliphatic triols having 3 to 10 carbon atoms. A particularly preferred initiator for making nominal polyether triols is glycerol.

Although propylene oxide and ethylene oxide are the preferred alkylene oxides used for manufacturing the flexible polyether polyols suitable for use in the prepolymers of the invention; it is within the scope of the invention, although less preferred, to include minor amounts of other alkylene oxides into any or all of the flexible polyether polyols used. When these additional alkylene oxides are employed at all, it is preferred that they collectively comprise less than 10% by weight of any of the polyether polyols. Examples of additional alkylene oxides that might be included in the production of the flexible polyether polyols are: butylene oxide, styrene oxide, epihalohydrins such as epichlorohydrin and epibromohydrin, epoxidized alpha olefins of 5 to 20 carbon atoms which are otherwise free of isocyanate reactive groups, mixtures of these, and the like.

Polyols i and ii are oxyethylene terminated (capped) polyols. Polyol iii optionally contains an oxyethylene cap, but is more preferably not oxyethylene capped. Although it is preferred that all of the ethylene oxide used in the manufacture of the flexible polyols be used in the formation of the oxyethylene termini, it is within the scope of the invention to include minor amounts of ethylene oxide in the main chain also. Ethylene oxide may be incorporated in the main chain randomly, or as blocks. It is preferable that the level of ethylene oxide in the main chain (and exclusive of that used in the oxyethylene termini) comprise less than 10% of the weight of each polyol, and more preferably 5% or less.

The use of extraordinary measures to prevent or remove terminal unsaturation in the manufacture of any of these polyols is not necessary and, in fact, not desirable in the practice of the instant invention. The polyols used in the practice of this invention may be described as “conventional”, in order to distinguish them from the newer and more specialized low-unsaturation polyether polyols. The latter are characterized by having levels of terminal unsaturation below the levels specified hereinabove, for each of the three flexible polyether polyol structures used.

An example of a flexible polyether polyol suitable for use as polyol-i is JEFFOL® PPG-3709 polyol, available commercially from Huntsman Polyurethanes. This polyol is a nominal diol with an hydroxyl equivalent weight of 1870, and contains 27% by weight of oxyethylene termination. The main chain of the polyol is derived from oxypropylation of dipropylene glycol. This conventional polyether polyol, which is produced using KOH catalysis, has terminal unsaturation in the range of 0.03 to 0.065 meq/g.

An example of a flexible polyether polyol suitable for use as polyol-ii is JEFFOL® G-31-36 polyol, commercially available from Huntsman Polyurethanes. This polyol is an oxypropylated glycerol having 10% by weight oxyethylene termination and an additional 5% by weight of oxyethylene incorporated into the main chain. The polyol, which is produced by conventional KOH catalysis, has a level of terminal unsaturation in the range of 0.038 to 0.058 meq/g and an hydroxyl equivalent weight of 1560. This polyol is a nominal triol.

An example of a flexible polyether polyol suitable for use as polyol-iii in the invention is JEFFOL® PPG-2000 polyol, which is commercially available from Huntsman Polyurethanes. This polyol has an hydroxyl equivalent weight of 1000 and no oxyethylene cap. The polyol is a polyoxypropylene nominal diol produced by conventional KOH catalysis, having a terminal unsaturation level of 0.04 meq/g.

Although less preferred, it is within the scope of the invention to incorporate into the inventive prepolymers minor amounts of other polyols different from polyols i, ii, or iii. When additional polyols are used it is highly preferred that they comprise less than 5% by weight of the total prepolymer composition, preferably less than 3%, more preferably less than 2%, still more preferably less than 1%, and ideally less than 0.1% by weight of the total prepolymer composition. Non-limiting examples of the additional polyols which might be incorporated into the prepolymers of the invention would be polyester polyols; and low molecular weight glycols such as tripropylene glycol, propylene glycol, diethylene glycol, and dipropylene glycol.

The prepolymers of the invention may optionally contain an inert and substantially non-volatile diluent, generally in amounts less than 15% by weight of the total prepolymer composition (including the diluent). Although the diluent is optional, its use is generally preferred. The diluent helps to reduce the viscosity of the prepolymer and improves its liquid storage stability. By “inert” it is meant that the diluent is free of chemical groups that are reactive towards isocyanate groups at temperatures of 80° C. or lower. The diluents are, for example, free of active hydrogen species such as water, alcohols, amines, carboxylic acids, and the like, which would react with the isocyanates present. The diluents are liquids which are miscible with the prepolymer, at the intended use levels, which most preferably have viscosities at 25° C. which are lower than that of the undiluted prepolymer. By “substantially non-volatile” it is meant that the diluent has a boiling point of greater than 150° C. at atmospheric pressure, and preferably has a boiling point of 200° C. or greater at atmospheric pressure. The diluents used most preferably all have flash points of 93° C. or greater (as determined by the open cup method) at atmospheric pressure. Examples of suitable diluents include cyclic alkylene carbonates such as propylene carbonate; simple dialkyl carbonates such as diethyl carbonate; inert tertiary amides such as N-methyl pyrrolidinone, N,N dimethyl acetamide, and N,N dimethyl formamide; liquid fatty esters such as butyl oleate, tridecyl stearate, octyl laurate, hexyl oleate, cyclohexyl 2-ethylhexanoate, octadecyl 2-ethylhexanoate, tripropylene glycol dioleate, triethylene glycol di-(2-ethylhexanoate), diisooctyl phthalate, mixtures of these, and the like; liquid triglycerides such as linseed oil, soya oil, epoxidized linseed oil, epoxidized soyabean oil, peanut oil, rapeseed oil, safflower oil, mixtures of these, and the like; and hydrocarbon oils such as aromatic, aliphatic, and araliphatic hydrocarbon process oils. Mixtures of these and other suitable diluents may be used. A highly preferred liquid diluent is propylene carbonate. The more preferred level of the inert diluent in the prepolymer is 10% by weight, of the total prepolymer composition (inclusive of the diluent).

The prepolymers of the invention are urethane prepolymers in which preferably the polyol species are at least about 80% reacted and more preferably 100% reacted to form isocyanate terminated urethane species. Procedures for making prepolymers are well known to the skilled artisan. Any suitable procedure for making a prepolymer from the ingredients specified hereinabove, which provides a resultant prepolymer composition consistent with the specifications provided hereinabove, is an acceptable means for making the prepolymer compositions of the invention. Typically, the base isocyanate composition is blended under an inert atmosphere at a temperature higher than the melting point of the MDI isomers present. The polyols are then added, either separately or as a mixture, to the base isocyanate while the latter is agitated under inert atmosphere. If the polyols are added separately they may be added in any order. The rate of polyol addition is such that the exotherm of the reaction is contained. Ideally, the exotherm due to the reaction of the polyols with the base isocyanate should be controlled such that the reaction temperature is maintained below 100° C., and preferably below 90° C. This may be achieved by adding the polyols at a steady rate over a period of time, typically 1 to 3 hours, while the reaction mixture is stirred. If the reaction mixture is large, then external cooling of the reactor may be required in order to maintain a suitable reaction temperature. After the addition of the polyols is completed, the reaction is typically heated an additional 1 to 3 hours at a cook temperature of 70 to 80° C., with continued agitation. This is done in order to ensure that the polyols are fully reacted with the isocyanates to form isocyanate terminated urethane species. The prepolymer is then allowed to cool to ambient temperature and stored under an inert atmosphere, such as dry air or dry nitrogen. The prepolymers may optionally be prepared at a lower temperature, such as 50° C., but with a longer cook time, such as 12 hours. In a preferred method for making the prepolymers of the invention, the polyols are pre-blended and added to the base MDI isocyanate together. It is however within the scope of the invention to react the polyols with a sub-portion of the base MDI isocyanates, and then introduce the remaining MDI isocyanate species by blending later. It would, for example, be suitable to react the polyols with the mixture of MDI isomers to form an intermediate prepolymer, and then to blend in the appropriate amount of uretonimine-carbodiimide modified MDI (as MDI ingredient iv) after the prepolymerization reaction is completed and the intermediate prepolymer has been cooled. It would also be acceptable, although less preferred, to react the individual polyols with sub-portions of the base MDI isocyanate composition and then to later blend the resulting intermediate prepolymers together to form the final prepolymer.

The inert diluent, if used, may be introduced at any point in the manufacturing process. It may be added to the base MDI isocyanate mixture or portions thereof, it may be mixed with the polyols or portions thereof, it may be introduced simultaneously with the polyols during the polyol addition phase, it may be added during the cook phase, or it may be introduced into the prepolymer after the reaction between the polyols and the isocyanates is completed. The lattermost method is usually preferred.

The relative amounts of the three main types of ingredients (the MDI base isocyanate composition, the polyol composition, and the inert diluent if a diluent is to be used) are proportioned such that the desired final free —NCO content of the prepolymer composition is achieved. The prepolymers according to the invention have final free isocyanate (free —NCO) concentrations in the range of 5% to 12%, preferably 7% to 11%, and more preferably 8% to 10%.

The prepolymer compositions according to the invention may be advanced further by the ultimate end user, by reaction of the prepolymer with additional polyols to produce a lower free —NCO concentration. Often the end user may wish to advance the prepolymer in this way to achieve free —NCO levels in the range of from about 0.5% to about 3.5% by weight. In certain applications the prepolymers or, more commonly, the advanced derivatives of these prepolymers, are terminated with moisture crosslinking silane groups. Silane capping is achieved by reacting the residual free —NCO groups on the prepolymer with an isocyanate reactive monomeric silane, such as an hydroxy or amino functional trialkoxysilane. The resulting trialkoxysilane terminated resins will then cure in the presence of moisture to form elastomers with siloxane crosslinks. The low viscosity of the prepolymers is especially attractive in these types of applications, since the low initial viscosity translates into lower viscosity in the advanced prepolymer, and the silane functional derivatives thereof. Similarly, the physical property benefits seen in elastomers prepared directly from the prepolymers translate into better properties in elastomers made from the derived (advanced) prepolymers as prepared by the end user, including the elastomers made from silane terminated derivatives of these prepolymers.

The prepolymers, and advanced derivatives thereof, may if desired be used with additives known in the art. These additives may include catalysts, fillers, dyes, pigments, surfactants, fire retardants, mixtures of these, and the like. Certain catalysts have been formulated as additives in moisture curing prepolymers in order to accelerate the cure. Catalysts that have been found to be generally effective in this application, without unacceptably compromising the stability of the prepolymers, include 2,2′-dimorpholinodiethylether (DMDEE) and 2,2′-dimethylaminodiethylether. These catalysts, when used, are typically employed at concentrations of between 0.001% and 0.1% by weight relative to the total prepolymer composition.

The isocyanate functional prepolymer compositions according to the invention can be directly moisture cured to produce sealant elastomers with surprisingly attractive combinations of physical properties; most notably tensile strength, tear resistance, and ultimate elongation. Elastomers produced by direct moisture cure of an isocyanate terminated prepolymer contain urea linkages, formed from the isocyanate-water reaction. The combinations of properties exhibited by elastomers, derived directly or indirectly from the prepolymers of the invention, are unexpected and surprising, especially in view of the fact that the polyols used are all conventional polyether polyols having significant levels of terminal unsaturation. In many cases the physical properties of these elastomers were in fact found, very unexpectedly, to be much superior to the properties obtained from prepolymers made from commercially available samples of specialized “low-unsaturation” flexible polyether polyols having much lower levels of terminal unsaturation than the polyols used in the prepolymers of the instant invention. The prepolymers according to the invention also offer surprisingly low viscosities.

The advantages of the inventive prepolymer compositions are illustrated by the following non-limiting examples.

### EXAMPLES

### Example 1

A prepolymer according to the invention is formed from the following ingredients in the proportions by weight indicated:

| | |
|---|---|
| JEFFOL ® PPG-3709 polyol: | 44.14% |
| JEFFOL ® G 31-36 polyol: | 12.26% |
| JEFFOL ® PPG-2000 polyol: | 4.91% |
| RUBINATE ® 44 isocyanate: | 25.82% |
| RUBINATE ® 1680 isocyanate: | 2.87% |
| Propylene Carbonate: | 10.00% |

The prepolymer was prepared by placing the RUBINATE® 44 isocyanate and RUBINATE® 1680 isocyanate into a round-bottom flask equipped with a stir blade, stir bearing, stir shaft, addition funnel, nitrogen inlet, thermocouple, temperature controller, heating mantle and a stopper. The isocyanate was then heated up to 70° C. The polyol mixture, JEFFOL® PPG-3709 polyol, JEFFOL® G-31-36 polyol, JEFFOL® PPG-2000 polyol, was placed in the addition funnel and was added over 120 minutes with vigorous stirring. The mixture was allowed to react for an additional 60 minutes at 80° C. The heat was turned off at the end of 180 minutes. Propylene carbonate was added into the prepolymer when the temperature was cooled below 60° C. and mixed until a homogeneous mixture was obtained.

The viscosity of the resulted prepolymer was determined by Brookfield viscometer at 25° C. This liquid prepolymer had a final free —NCO content of 8% by weight and a viscosity at 25° C. of 1819 cps.

JEFFOL® PPG-3709 polyol, JEFFOL® G 31-36 polyol, and JEFFOL® PPG-2000 polyol are conventional flexible polyether polyols commercially available from Huntsman Polyurethanes. Their compositions have been defined above.

RUBINATE® 44 isocyanate is pure 4,4′-MDI, available from Huntsman Polyurethanes.

RUBINATE® 1680 isocyanate is a uretonimine-carbodiimide modified liquid variant of 4,4′-MDI having a free —NCO content of 29.3%, and an —NCO functionality between 2.03 and less than 2.10, available from Huntsman Polyurethanes.

This prepolymer is particularly suitable for making moisture cured elastomers of relatively high modulus (hardness).

### Example 2

A prepolymer according to the invention is formed from the following ingredients in the proportions by weight indicated:

| | |
|---|---|
| JEFFOL ® PPG-3709 polyol: | 44.14% |
| JEFFOL ® G 31-36 polyol: | 12.26% |
| JEFFOL ® PPG-2000 polyol: | 4.91% |
| MI-50: | 25.82% |
| RUBINATE ® 1680 isocyanate: | 2.87% |
| Propylene Carbonate: | 10.00% |

The prepolymer was prepared by placing the MI-50 isocyanate and RUBINATE® 1680 isocyanate into a round-bottom flask equipped with a stir blade, stir bearing, stir shaft, addition funnel, nitrogen inlet, thermocouple, temperature controller, heating mantle and a stopper. The isocyanate was then heated up to 70° C. The polyol mixture, JEFFOL® PPG-3709 polyol, JEFFOL® G-31-36 polyol, JEFFOL® PPG-2000 polyol, was placed in the addition funnel and was added over 120 minutes with vigorous stirring. The mixture was allowed to react for an additional 60 minutes at 80° C. The heat was turned off at the end of 180 minutes. Propylene carbonate was added into the prepolymer when the temperature was cooled below 60° C. and mixed until a homogeneous mixture was obtained.

The viscosity of the resulted prepolymer was determined by Brookfield viscometer at 25° C. This liquid prepolymer had a final free —NCO content of 8% by weight and a viscosity at 25° C. of 1783 cps.

JEFFOL® PPG-3709 polyol, JEFFOL® G 31-36 polyol, and JEFFOL® PPG-2000 polyol are conventional flexible polyether polyols commercially available from Huntsman Polyurethanes. Their compositions have been defined hereinabove.

MI-50 is 1:1 w/w mixture of 4,4′-MDI and 2,4′-MDI, available from Huntsman Polyurethanes.

RUBINATE® 1680 isocyanate is a uretonimine-carbodiimide modified liquid variant of 4,4′-MDI having a free —NCO content of 29.3%, and an —NCO functionality between 2.03 and less than 2.10, available from Huntsman Polyurethanes.

This prepolymer is particularly suitable for making moisture cured elastomers of relatively low modulus (hardness), and exceptionally high elongation. The advantage of such prepolymers as this one, formulated for low-modulus and high-elongation elastomers, is to allow formulators to add more compounding species, such as fillers, plasticizers, and solvents, in order to reduce the cost of the final product with minimal sacrifice in ultimate physical properties.

### Examples 3 and 4

In these Examples, moisture cured elastomer film samples were prepared from the inventive prepolymers from Examples 1 and 2, as prepared in Examples 3 and 4.

Films from each prepolymer were made by applying the prepolymer to a sheet of clean glass. Films were leveled with a film applicator (from Paul N. Gardner Company). The films were allowed to react with atmospheric moisture (50% relative humidity) for several days. The films were removed from the glass by immersing the films in hot water. The films were then pulled gently from the glass.

The tensile strength and maximum elongation of the thin film were measured according to ASTM D882-95. The tear resistance was measured according to ASTM D624-91.

These are Film Samples 1 and 2, respectively. Key physical properties of these films are provided below:

| | Film Sample- | Film Sample- |
|---|---|---|
| | 1 | 2 |
| Prepolymer viscosity (cps) | 1819 | 1783 |
| Tensile (psi) | 1650 | 2500 |
| Elongation (%) | 1000 | 680 |
| Die C Tear (pli) | 265 | 475 |

### Examples 5 and 6

In these Examples, another set of two advanced prepolymers were made from the prepolymers of Examples 1 and 2 respectively, by further reaction of the prepolymers of Examples 1 and 2 with a mixture of JEFFOL® PPG-3709 polyol and JEFFOL® G 31-36 polyol, according to the following ingredients and procedure:

| JEFFOL ® PPG-3709 polyol: | 46.01% by weight |
|---|---|
| JEFFOL ® G31-36 polyol: | 11.51% |
| Prepolymer from Example 1: | 42.48% |

The first advanced prepolymer was prepared by placing the prepolymer from Example 1 into a round-bottom flask equipped with a stir blade, stir bearing, stir shaft, addition funnel, nitrogen inlet, thermocouple, temperature controller, heating mantle and a stopper. The prepolymer was then heated up to 70° C. The polyol mixture, JEFFOL® PPG-3709 polyol and JEFFOL® G-31-36 polyol, was placed in the addition funnel and was added over 120 minutes with vigorous stirring. The mixture was allowed to react for an additional 180 minutes at 80° C. The heat was turned off at the end of 300 minutes.

The advanced prepolymer of Example 5 had a final —NCO content of 2% by weight, and a viscosity at 25° C. of 21,778 cps.

The second advanced prepolymer was prepared by reacting the prepolymer of Example 2 with a mixture of JEFFOL® PPG-3709 polyol and JEFFOL® G 31-36 polyol, according to the following ingredients and procedure:

| JEFFOL ® PPG-3709 polyol: | 46.01% by weight |
|---|---|
| JEFFOL ® G31-36 polyol: | 11.51% |
| Prepolymer from Example 2: | 42.48% |

The prepolymer was prepared by placing the prepolymer from Example 2 into a round-bottom flask equipped with a stir blade, stir bearing, stir shaft, addition funnel, nitrogen inlet, thermocouple, temperature controller, heating mantle and a stopper. The prepolymer was then heated up to 70° C. The polyol mixture, JEFFOL® PPG-3709 polyol and JEFFOL® G-31-36 polyol, was placed in the addition funnel and was added over 120 minutes with vigorous stirring. The mixture was allowed to react for an additional 180 minutes at 80° C. The heat was turned off at the end of 300 minutes.

The advanced prepolymer of Example 6 had a final —NCO content of 2% by weight, and a viscosity at 25° C. of 18,946 cps.

### Examples 7 and 8

In these Examples two moisture cured elastomer film samples were made from the advanced prepolymers of Examples 5 and 6 respectively. These additional film samples are identified as Film Sample-3 and Film Sample-4. The key physical properties of these additional film samples are provided below. The same test methods were used as in Examples 3 and 4 above.

| | Film Sample- | Film Sample- |
|---|---|---|
| | 3 | 4 |
| Tensile (psi) | 1850* | 570* |
| Elongation | 1400* | 1400* |
| (%) | | |
| Die C Tear | 72* | 78* |
| (pli) | | |

*sample did not break after reaching the maximum of Instron elongation capability

### Example 9

In this Example, yet another advanced prepolymer is prepared, this time to a final free —NCO concentration of 0.8% by weight. This advanced prepolymer was prepared from the prepolymer of Example 2. The advanced prepolymer had a final viscosity at 25° C. of 35,100 cps, and was prepared according to the following procedure:

The prepolymer was made from the prepolymer of Example 2, by further reaction with a mixture of JEFFOL® PPG-3709 polyol, JEFFOL® G 31-36 polyol and JEFFOL® PPG-2000 polyol, according to the following ingredients and procedure:

| JEFFOL ® PPG-3709 polyol: | 50.18% by weight |
|---|---|
| JEFFOL ® G31-36 polyol: | 4.37% |
| JEFFOL ® PPG-2000 polyol: | 6.07% |
| Prepolymer from Example 2: | 29.38% |
| Propylene Carbonate: | 10.00% |

The prepolymer was prepared by placing prepolymer from Example 2 into a round-bottom flask equipped with a stir blade, stir bearing, stir shaft, addition funnel, nitrogen inlet, thermocouple, temperature controller, heating mantle and a stopper. The prepolymer was then heated up to 70° C. The polyol mixture, JEFFOL® PPG-3709, JEFFOL® G-31-36, JEFFOL® PPG-2000, was placed in the addition funnel and was added over 120 minutes with vigorous stirring. The mixture was allowed to react for an additional 180 minutes at 80° C. The heat was turned off at the end of 300 minutes. Propylene carbonate was added into the prepolymer when the temperature was cooled below 60° C. and mixed until a homogeneous mixture was obtained.

### Example 10

In this Example, a sample of moisture cured elastomeric film, labeled Film Sample-5, was prepared from the advanced prepolymer of Example 9, according to the following procedure:

A film of the prepolymer was made by applying the prepolymer to a sheet of clean glass. The film was leveled with a film applicator (from Paul N. Gardner Company). The film was allowed to react with atmospheric moisture (50% relative humidity) for several days. The film was removed from the glass by immersing the film in hot water. The film was then pulled gently from the glass.

The tensile strength and maximum elongation of the thin film were measured according to ASTM D882-95. The tear resistance was measured according to ASTM D624-91.

The key physical properties of the elastomer film prepared in this Example were measured using the same test procedures employed on the previous film samples. The properties are provided below:

| | Film Sample- |
|---|---|
| | 5 |
| Tensile (psi) | 6* |
| Elongation | 1400* |
| (%) | |
| Die C Tear | 28* |
| (ph) | |

*sample did not break after reaching the maximum of instron elongation capability.

### Example 11

In this Example, another advanced prepolymer was made from the prepolymer of Example 9 by further reaction of the prepolymer of Example 9 with SILQUEST® A-link 15 from Crompton Corporation, according to the following ingredients and procedure:

| | |
|---|---|
| SILQUEST ® A-link 15: | 3% |
| Prepolymer from Example 9: | 97% |

The advanced prepolymer was prepared by placing the prepolymer from Example 9 into a round-bottom flask equipped with a stir blade, stir bearing, stir shaft, addition funnel, nitrogen inlet, thermocouple, temperature controller, heating mantle and a stopper. The prepolymer was then heated up to 60° C. The SILQUEST® A-link 15 was placed in the addition funnel and was added over 120 minutes with mild stirring. The mixture was allowed to react for an additional 120 minutes at 60° C. The heat was turned off at the end of 240 minutes.

The advanced prepolymer of this Example had a final —NCO content of 0% by weight.

A sample of moisture cured elastomeric film, labeled Film Sample-6, was prepared from the advanced prepolymer of this Example, according to the following procedure:

A film of the prepolymer was made by applying the prepolymer to an aluminum mold coated with TEFLON® coating on the bottom of the mold. The film was allowed to react with atmospheric moisture (50% relative humidity) for several days. The film was removed from the aluminum mold with TEFLON® coating after 48 hours of curing in the atmosphere.

The tensile strength and maximum elongation of the thin film were measured according to ASTM D882-95. The tear resistance was measured according to ASTM D624-91.

The key physical properties of the elastomer film prepared in this Example were measured using the same test procedures employed in the previous Examples. The properties are provided below:

| | Film Sample-6 |
|---|---|
| Tensile (psi): | 83 |
| Tensile at 100% Elongation: | 31 |
| Tensile at 200% Elongation: | 48 |
| Tensile at 300% Elongation: | 62 |
| Elongation (%): | 415 |
| Die C Tear (pli): | 27 |

### Comparative Examples 1 -10

Comparative polyether prepolymers were prepared from commercial samples of low unsaturation flexible polyoxypropylene based polyether polyols. These prepolymers were all advanced prepolymers, having final free —NCO concentrations of 1.7% by weight. The polyether polyols used in this comparative study all had unsaturation levels of less than 0.01 meq/g. The prepolymers were prepared from a combination of a 4,000 MW nominal diol and a 6,000 MW nominal triol at a series of different polyol ratios with pure MDI (MONOLUR® M isocyanate from Bayer Corporation) as an isocyanate. These low unsaturation polyoxypropylene based polyols were obtained from ARCO/Lyondell/Bayer, under the ACCLAIM trade name. The polyol molecular weights are number averaged. Samples of moisture cured elastomer films were prepared from each prepolymer, and the key properties of the films were tested. The key physical properties of these comparative film samples are summarized in the table below, as a function of the weight percent of the triol in the prepolymer formulation:

| | | 100% | | Tensile | Die C | |
|---|---|---|---|---|---|---|
| Triol | Hardness | Modulus | Rebound | Strength | Tear | Elongation |
| (wt %) | (shore A) | (psi) | (%) | (psi) | (pli) | (%) |
| 0 | 30 | 50 | 55 | 43 | 26 | 490 |
| 1 | 30 | 49 | 54 | 48 | 25 | 660 |
| 3 | 30 | 46 | 57 | 82 | 27 | 1570 |
| 5 | 33 | 60 | 56 | 310 | 71 | 1370 |
| 7 | 35 | 68 | 65 | 425 | 81 | 1380 |
| 10 | 47 | 132 | 69 | 280 | 84 | 460 |
| 20 | 49 | 145 | 73 | 220 | 72 | 235 |
| 40 | 51 | 167 | 75 | 180 | 38 | 117 |
| 60 | 53 | 192 | 76 | 175 | 33 | 91 |
| 80 | 55 | — | 79 | 163 | 27 | 74 |
| 100 | 56 | — | 85 | 157 | 22 | 64 |

The results from the table above indicates that the best performed formulation based on premium, low unsaturation polyols are 425 psi for tensile strength, 81 pli for Die C Tear strength, and 1380% for elongation. The results from Film Sample 3 and Film Sample 4 are comparable, and superior in certain properties. This clearly indicates that high performance sealants can also be formulated with conventional polyols.

The prepolymers according to the invention represent a new formulating concept which makes possible the preparation of moisture cured elastomers suitable for use as high performance sealants without the necessity of using premium low-unsaturation polyether polyols. The new formulating concept is a cost effective way to achieve elastomer properties comparable, and in many cases superior, to properties obtained from formulations based on the premium low unsaturation polyols. The prepolymers according to the invention have attractive viscosity ranges and, as such, offer the formulator more choices in prepolymer compositions as precursors to high performance moisture cured sealant elastomers. The prepolymers of the invention may also be exploited in a broader range of moisture cured elastomer applications, including but not limited to coatings, films, and adhesives.

What is claimed:

1. A urethane prepolymer composition suitable for use as a moisture curable one component sealant precursor, said prepolymer comprising the reaction product of:
A) a base isocyanate composition consisting essentially of:
i) 40-100% by weight of 4,4′-diphenylmethane diisocyanate,
ii) optionally up to 55% by weight of 2,4′-diphenylmethane diisocyanate,
iii) optionally up to 2% by weight of 2,2′-diphenylmethane diisocyanate, and
iv) a total of 0 to 5% by weight of one or more members selected from the group consisting of uretonimine or uretonimine-carbodiimide modified diphenylmethane diisocyanate species of functionality greater than 2.0, and tri- or higher functionality oligomers of the polymethylene polyphenyl polyisocyanate series;
wherein the weights of said isocyanate ingredients i-iv add up to 100% of said base isocyanate composition A, and the number averaged isocyanate group functionality of the said base isocyanate composition A is from 2.00 to 2.03;
B) a combination of polyether polyols consisting essentially of:
i) from 60 to 90% by weight of a polyoxyethylene terminated polyoxypropylene nominal diol having a number averaged hydroxyl equivalent weight of from 1200 to 2500, a concentration of terminally unsaturated species of not less than 0.03 meq/g, and a terminal oxyethylene content of from 22 to 40% by weight,
ii) from 10 to 25% by weight of a polyoxyethylene terminated polyoxypropylene nominal triol or tetrol having a number averaged hydroxyl equivalent weight of from 1200 to 2500, a concentration of terminally unsaturated species of not less than 0.04 meq/g, and a terminal oxyethylene content of from 5 to 25% by weight, and
iii) from 5 to 15% by weight of a polyoxypropylene or a polyoxyethylene terminated polyoxypropylene nominal diol having a number averaged hydroxyl equivalent weight from 500 to less than 1200, a concentration of terminally unsaturated species of not less than 0.015 meq/g, and a terminal oxyethylene content of from 0 to 10%;
wherein the weights of said polyether polyol ingredients i-iii add up to 100% of said polyol combination B; and
C) optionally, an inert and substantially non-volatile diluent, in an amount less than 15% by weight of the total prepolymer composition,
wherein said urethane prepolymer composition is further characterized by being liquid at 25° C., having a final concentration of free isocyanate (—NCO) groups of from 5 to 12%, and a viscosity at 25° C. of less than 15,000 cps.

2. The urethane prepolymer composition according to claim 1, wherein the component (iv) of the base isocyanate composition A includes a total of from 0.1 to 5% by weight of one or more members selected from the group consisting of: uretonimine or uretonimine-carbodiimide modified diphenylmethane diisocyanate species of functionality greater than 2.0, and tri- or higher functionality oligomers of the polymethylene polyphenyl polyisocyanate series.

3. The urethane prepolymer according to claim 1, which contains at least one inert diluent, wherein all the inert diluents present collectively constitute from 1 to 14% by weight of the total prepolymer composition: A+B+C, and wherein all said inert diluents present individually have boiling points at 1 atmosphere pressure of greater than 150° C.

4. The urethane prepolymer according to claim 1, wherein the urethane prepolymer remains clear and free of solids for at least 30 days of storage at 25° C., and wherein the viscosity of the prepolymer measured at 25° C. remains less than 15,000 cps. after 30 days of storage at 25° C.

5. The urethane prepolymer according to claim 1, wherein the inert diluent comprises propylene carbonate.

6. The urethane prepolymer according to claim 3, wherein the urethane prepolymer has a viscosity measured at 25° C. of less than 10,000 cps after 30 days storage at 25° C.

7. The urethane prepolymer according to claim 5, wherein the urethane prepolymer has a viscosity measured at 25° C. of less than 5000 cps after 30 days storage at 25° C.

8. The urethane prepolymer according to claim 3, wherein the urethane prepolymer has a viscosity measured at 25° C. of less than 4000 cps after 30 days storage at 25° C.

9. The urethane prepolymer according to claim 3, wherein the urethane prepolymer has a viscosity measured at 25° C. of less than 3000 cps. after 30 days storage at 25° C.

10. The urethane prepolymer according to claim 3, wherein the urethane prepolymer has a viscosity measured at 25° C. of less than 2500 cps after 30 days storage at 25° C.

11. The urethane prepolymer according to claim 1, wherein all the polyether polyols, in the combination of polyether polyols B, are synthesized by using an alkoxylation catalyst selected from the group consisting of potassium hydroxide, sodium hydroxide, and mixtures thereof.

12. The urethane prepolymer according to claim 1, wherein all the polyether polyols, in the combination of polyether polyols B, are synthesized by using a member selected from the group consisting of potassium hydroxide, sodium hydroxide, and mixtures thereof as the sole alkoxylation catalyst.

13. The urethane prepolymer according to claim 1, wherein all the polyether polyols, in the combination of polyether polyols B, are synthesized by using potassium hydroxide as the sole alkoxylation catalyst.

14. The urethane prepolymer according to claim 12, wherein the free isocyanate (—NCO) group concentration is from 8 to 10% by weight.

15. The urethane prepolymer according to claim 1, wherein the polyol B-ii is a nominal triol.

16. A urethane prepolymer composition suitable for use as a moisture curable one component sealant precursor, said prepolymer comprising the reaction product of:
A) a base isocyanate composition consisting essentially of:
i) 50 to 99% by weight of 4,4′-diphenylmethane diisocyanate,
ii) 0.01 to 50% by weight of 2,4′-diphenylmethane diisocyanate,
iii) optionally up to 2% by weight of 2,2′-diphenylmethane diisocyanate, and
iv) a total of from 1 to 3% by weight of one or more members selected from the group consisting of uretonimine or uretonimine-carbodiimide modified diphenylmethane diisocyanate species of functionality greater than 2.0, and tri- or higher functionality oligomers of the polymethylene polyphenyl polyisocyanate series;
wherein the weights of the isocyanate ingredients i-iv add up to 100% of the base isocyanate composition A, and the number averaged isocyanate group functionality of the base isocyanate composition is from 2.00 to about 2.03;
B) a combination of polyether polyols consisting essentially of:
i) from 70 to 85% by weight of a polyoxyethylene terminated polyoxypropylene nominal diol having a number averaged hydroxyl equivalent weight of from 1200 to 2500, a concentration of terminally unsaturated species of not less than 0.03 meq/g, and a terminal oxyethylene content of from 22 to 40% by weight;
ii) from 15 to 20% by weight of a polyoxyethylene terminated polyoxypropylene nominal triol having a number averaged hydroxyl equivalent weight of from 1200 to 2500, a concentration of terminally unsaturated species of not less than 0.04 meq/g, and a terminal oxyethylene content of from 5 to 25% by weight;
iii) from 8 to 12% by weight of a polyoxypropylene or a polyoxyethylene terminated polyoxypropylene nominal diol having a number averaged hydroxyl equivalent weight from 500 to less than 1200, a concentration of terminally unsaturated species of not less than 0.015 meq/g, and a terminal oxyethylene content of from 0 to 10%;
wherein the weights of the polyether polyol ingredients i-iii add up to 100% of the polyol combination B; and
C) an inert and substantially non-volatile diluent, in an amount less than 15% by weight of the total prepolymer composition: A+B+C;
wherein the urethane prepolymer composition is further characterized by being a clear liquid at 25° C., having a final concentration of free isocyanate (—NCO) groups of from 7 to 11%, and a viscosity measured at 25° C. of less than 10,000 cps. after 30 days storage at 25° C.

17. The urethane prepolymer according to claim 16, wherein the polyol component B-i) has a number averaged hydroxyl equivalent weight of greater than 1500 and less than 2500, with an oxyethylene content of greater than 25% and less than 35% by weight.

18. The urethane prepolymer according to claim 16, wherein the polyol component B-iii) has a number averaged hydroxyl equivalent weight of greater than 800 and less than 1 100.

19. The urethane prepolymer according to claim 2, wherein the urethane prepolymer contains at least one inert diluent, wherein all inert diluents present collectively constitute from 1 to 14% by weight of the total prepolymer composition: A+B+C, and wherein all the inert diluents present individually have boiling points at 1 atmosphere pressure of greater than 150° C.

20. The urethane prepolymer according to claim 2, wherein the inert diluent comprises propylene carbonate.

21. The urethane prepolymer according to claim 2, wherein the urethane prepolymer remains clear and free of solids for at least 30 days of storage at 25° C., and wherein the viscosity of the prepolymer measured at 25° C. remains less than 10,000 cps. after 30 days of storage at 25° C.

22. The urethane prepolymer according to claim 21, wherein the free isocyanate (—NCO) group concentration is from 8 to 10% by weight.

23. The urethane prepolymer according to claim 22, wherein the polyol component B-ii) is a nominal triol.
